(19) United States
(12) Patent Application Publication
(10) Pub. No.: US 2021/0047050 A1
(43) Pub. Date: Feb. 18, 2021

(54) Event-Based Aircraft Sense and Avoid System

(71) Applicant: Qelzal Corporation, Encinitas, CA (US)

(72) Inventor: Olivier Coenen, San Diego, CA (US)

(21) Appl. No.: 16/478,098

(22) PCT Filed: May 5, 2017
(86) PCT No.: PCT/US17/31448

§ 371 Date: Jul. 15, 2019

Related U.S. Application Data
(60) Provisional application No. 62/333,062, filed on May 6, 2016.

(51) Int. Cl. B64D 45/04; B64D 47/06

(52) U.S. Cl. CPC B64D 45/04; B64D 47/06

(57) ABSTRACT

In one embodiment, a detection system includes one or multiple sensors that detects a plurality of signals; a processor that identifies a relationship between the plurality of signals and determines whether the relationship between the plurality of signals corresponds to a characteristic of aircraft lights; and a output module that generates an aircraft-detection output in accordance with a determination that the relationship corresponds to a characteristic of aircraft lights.

### CROSS-REFERENCE TO RELATED APPLICATIONS

This application claims priority from U.S. provisional application No. 62/333,062 filed May 6, 2016, entitled “Event-Based Aircraft Sense and Avoid System,” the contents of which are incorporated by reference in its entirety.

### FIELD

This disclosure generally relates to systems and methods for aircraft sensing and avoiding. More particularly, this disclosure relates to event-based systems and methods for aircraft sensing and avoiding.

### BACKGROUND

Automated aircraft detection and avoidance has taken on heightened importance. For example, unmanned aerial vehicles navigate without human intervention, but may require remote assistance to avoid other airborne vehicles. Automated aircraft detection and avoidance may reduce the requirement for such remote assistance.

### BRIEF SUMMARY

This disclosure generally relates to systems and methods for aircraft sensing and avoiding. More particularly, this disclosure relates to event-based systems and methods for aircraft sensing and avoiding.

In one aspect, provided herein is a detection method. The detection method includes detecting, at a sensor, a plurality of signals; identifying, at a processor, a relationship between the plurality of signals and determining, at the processor, whether the relationship between the plurality of signals corresponds to a characteristic of aircraft lights. In accordance with a determination that the relationship corresponds to a characteristic of aircraft lights, an aircraft-detection output is generated. In accordance with a determination that the relationship does not correspond to the characteristic of aircraft lights, the aircraft-detection output is not generated.

In some embodiments, detecting the plurality of signals includes detecting, at the sensor, activation of each of the plurality of signals and detecting, at the sensor, deactivation of each of the plurality of signals. Identifying the relationship between the plurality of signals includes identifying, at the processor, a time difference between activation of each signal and deactivation of the signal.

In some embodiments, the detection method includes determining, at the processor, whether the relationship between the plurality of signals corresponds to a pulse duration of aircraft anti-collision lights.

In some embodiments, the detection method includes determining, at the processor, whether the relationship between the plurality of signals corresponds to a pulse duration of aircraft steady navigation lights.

In some embodiments, detecting the plurality of signals includes detecting, at the sensor, activation of each of the plurality of signals; detecting, at the sensor, deactivation of each of the plurality of signals. Identifying the relationship between the plurality of signals comprises at least one selected from identifying, at the processor, a time difference between activation of each signal and the activation of the next signal; and identifying, at the processor, a time difference between deactivation of each signal and the deactivation of the next signal.

In some embodiments, the detection method includes determining, at the processor, whether the relationship between the plurality of signals corresponds to a frequency of aircraft anti-collision lights.

In some embodiments, the detection method includes determining, at the processor, whether the relationship between the plurality of signals corresponds to a frequency of aircraft steady navigation lights.

In some embodiments, identifying the relationship between the plurality of signals includes determining, at the processor, a frequency distribution of the plurality of signals.

In some embodiments, determining the frequency distribution of the plurality of signals includes computing, at the processor, an event-based Fourier Transform based on the plurality of signals.

In some embodiments, computing the event-based Fourier Transform based on the plurality of signals includes updating, at the processor, a previously computed event-based Fourier Transform.

In some embodiments, the detection method includes determining, at the processor, whether the relationship between the plurality of signals corresponds to a frequency of aircraft anti-collision lights.

In some embodiments, the detection method includes determining, at the processor, whether the relationship between the plurality of signals corresponds to a frequency of aircraft steady navigation lights.

In some embodiments, the sensor is a continuous visual sensor.

In some embodiments, the sensor is an event-based visual sensor.

In some embodiments, the detection method includes removing all sources of lights known not to be from aircrafts before detecting activation of signals.

In some embodiments, the detection method includes identifying the shape of the aircraft.

In some embodiments, the detection method includes filtering the lights before detecting activation of signals.

In some embodiments, the detection method includes determining light intensity.

In some embodiments, the detection method includes determining situational cues.

In another aspect, provided is a detection system. The detection system includes a sensor that detects a plurality of signals; a processor that identifies a relationship between the plurality of signals and determines whether the relationship between the plurality of signals corresponds to a characteristic of aircraft lights; and an output module that generates an aircraft-detection output in accordance with a determination that the relationship corresponds to a characteristic of aircraft lights.

In some embodiments, the sensor detects activation of each of the plurality of signals and deactivation of each of the plurality of signals and the processor identifies a time difference between activation of each signal and deactivation of the signal.

In some embodiments, the characteristic is a pulse duration of aircraft anti-collision lights.

In some embodiments, the characteristic is a pulse duration of aircraft steady navigation lights.

In some embodiments, the sensor detects activation of each of the plurality of signals and deactivation of each of the plurality of signals and the processor identifies a relationship between the plurality of signals comprising at least one selected from: a time difference between activation of each signal and the activation of the next signal; and a time difference between deactivation of each signal and the deactivation of the next signal.

In some embodiments, the characteristic is a frequency of aircraft anti-collision lights.

In some embodiments, the characteristic is a frequency of aircraft steady navigation lights.

In some embodiments, the processor identifies a relationship between the plurality of signals comprising a frequency distribution of the plurality of signals.

In some embodiments, the processor computes an event-based Fourier Transform based on the plurality of signals.

In some embodiments, the processor updates a previously computed event-based Fourier Transform.

In some embodiments, the characteristic is a frequency of aircraft anti-collision lights.

In some embodiments, the characteristic is a frequency of aircraft steady navigation lights.

In some embodiments, the sensor is a continuous visual sensor.

In some embodiments, the sensor is an event-based visual sensor.

In some embodiments, the system includes a module for removing all sources of lights known not to be from aircrafts before detecting activation of signals.

In some embodiments, the system includes a module for filtering the lights before detecting activation of signals.

In some embodiments, the system includes a module for identifying the shape of the aircraft.

In some embodiments, the system includes a module for determining light intensity.

In some embodiments, the system includes a module for determining situational cues.

### BRIEF DESCRIPTION OF THE DRAWINGS

FIG. 1 depicts running navigation lights, anti-collision flashing lights, and a tail light on a commercial aircraft during flight below 10,000 feet, in accordance with an embodiment.

FIG. 2 depicts a sensor's response to anti-collision lights of an aircraft seen head-on, in accordance with an embodiment.

FIG. 3 depicts a single impulse of a flash tube, in accordance with an embodiment.

FIG. 4 depicts anti-collision LED lights blinking sequence of one product for an Airbus 320 from the UTC Corporation, in accordance with an embodiment.

FIG. 5 depicts an aircraft in flight shown at the time that the anti-collision lights flash and tail light flashes as the aircraft travels, in accordance with an embodiment.

FIG. 6 depicts some of the other possible flashing sequences on different aircrafts, in accordance with an embodiment.

FIG. 7 depicts wave propagation of events on a sensor to adjacent pixels following a flash pulse of light, in accordance with an embodiment.

FIG. 8 depicts flashing sequence and potential event response from a sensor, in accordance with an embodiment.

FIG. 9 depicts another flashing sequence and potential event response from sensor, in accordance with an embodiment.

FIG. 10 depicts other examples of the flashing sequences and sensor responses, in accordance with an embodiment.

FIG. 11 depicts an original signal encoded by a series of positive and negative events, in accordance with an embodiment.

FIG. 12 depicts the approximated signal, in accordance with an embodiment.

FIG. 13 depicts an asynchronous discrete time Fourier transform of a sine wave sampled stochastically, in accordance with an embodiment.

FIG. 14 depicts a traditional discrete time Fourier transform of the same sine function, in accordance with an embodiment.

FIG. 15 depicts the frequencies of some of the highest asynchronous discrete time Fourier transform coefficients of a sine wave sampled stochastically for which the frequency was systematically changed every 400 time steps, in accordance with an embodiment.

FIG. 16 depicts the amplitudes of the asynchronous discrete time Fourier transform coefficients of a sine wave sampled stochastically at different frequencies and for which the frequency was systematically changed every 100 time steps, in accordance with an embodiment.

FIGS. 17A and 17B depict photos of a plane landing captured by a conventional camera, in accordance with an embodiment.

FIGS. 18A and 18B depict accumulated images from a video of a plane landing captured by an event-based vision (EBV) sensor, in accordance with an embodiment.

FIG. 18B depict the resulting accumulated images following filtering the street lights, in accordance with an embodiment.

FIG. 19A depicts an aircraft contour captured with an EBV sensor; FIG. 19B depicts an aircraft image captured with a conventional camera, in accordance with an embodiment.

FIG. 20 illustrates a scheme for estimating the motion of an aircraft for tracking the anti-collision lights over time, in accordance with an embodiment.

FIG. 21 illustrates an aircraft detection method, in accordance with an embodiment.

### DETAILED DESCRIPTION

In the following description of embodiments, reference is made to the accompanying drawings which form a part hereof, and in which it is shown by way of illustration specific embodiments in which the claimed subject matter may be practiced. It is to be understood that other embodiments may be utilized and structural changes may be made without departing from the scope of the claimed subject matter.

In the U.S., the Federal Aviation Administration (FFA) regulates that commercial aircrafts are fitted with anti-collision lights flashing between 40-100 cycles per minutes (0.67 Hz to 1.67 Hz) and with overlap of all lights with a max 180 cycles per minutes (3 Hz-333 ms) (Title 14, Chapter I, Subchapter C, Part 25, Subpart F Equipment, Part 25.1401). The anti-collision lights by regulations, if present, must be turned on at all times, day and night (CFR Part 91.209). “Pilots are further encouraged to turn on their landing lights when operating below 10,000 feet, day or night” (FAA Chapter 4, Section 3, Airport Operations, 4-3-23). The flashes are brief, and some have been observed to last only about 2 to 7 ms. Some aircraft anti-collision lights may fire in rapid short-term pattern of bursts, followed by longer pauses, such as 3 bursts, then long pause. Others may flash at regular intervals.

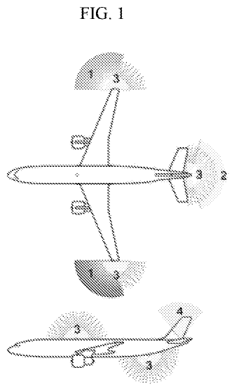

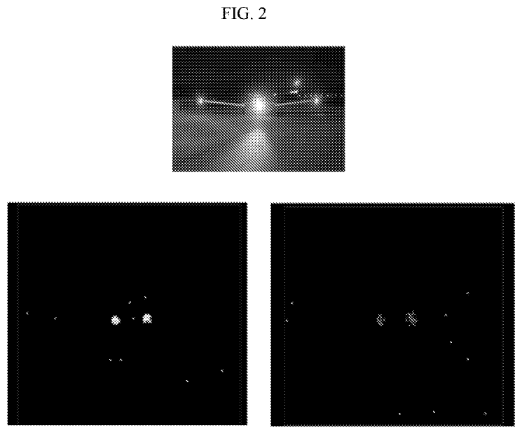

In addition, many commercial aircrafts have a 400 Hz power generator (2.5 ms period) instead of the regular electric grid lines oscillating at 60 Hz (16.7 ms period) for lightweight voltage generation onboard. Their steady lights, such as red and green position lights, may in reality oscillate rapidly at 800 Hz (2×400 Hz). FIG. 1 depicts the running navigation lights (1, 2), the anti-collision flashing lights (3), and the tail light (4) on a commercial aircraft during flight below 10,000 feet. FIG. 2 depicts sensor response to anti-collision lights of an aircraft seen head-on during flash onset and flash offset.

In the U.S., Federal Aviation Administration (FAA), the visual flight rules during night require approved position lights and approved aviation red or aviation white anti-collision light system on all U.S.-registered civil aircraft (Sec. 91.205). For visual flight rules during the day, the anti-collision light system is also required for small civil airplanes certificated after Mar. 11, 1996.

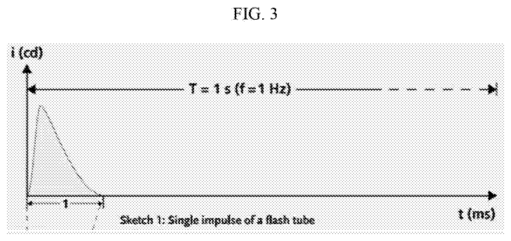

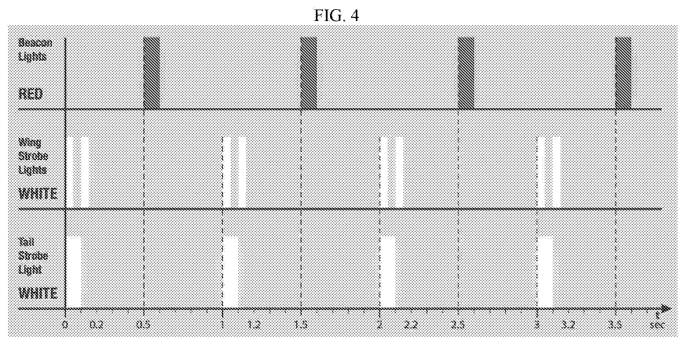

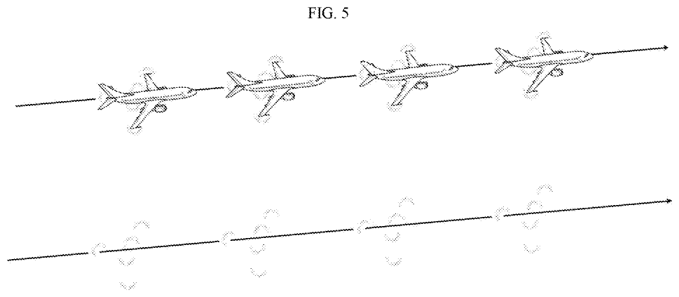

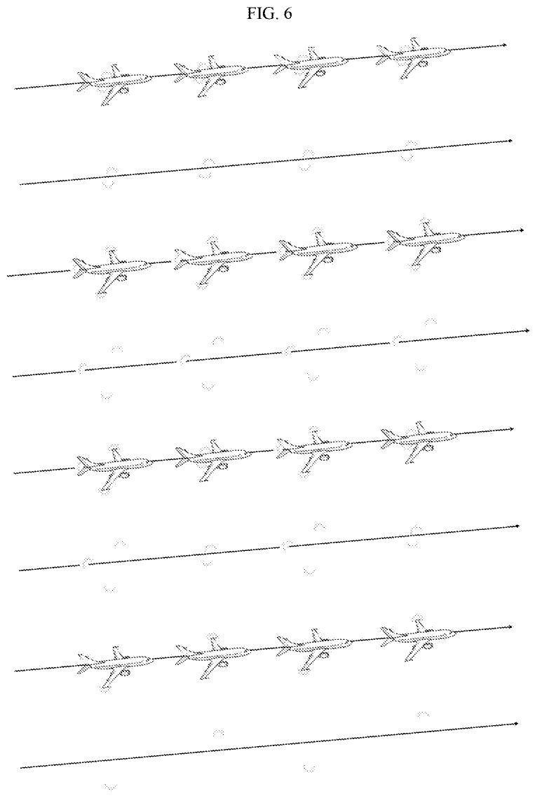

Anti-collision lights are made of different types of lights, such as flashtube and LEDs. FIG. 3 depicts a single impulse of a flash tube and light intensity over time produced by the pulse of a flash tube. The peak duration occurs in about 0.2 ms, with the entire pulse duration lasting about 1 ms. FIG. 4 depicts anti-collision LED lights blinking sequence of one product for an Airbus 320 from the UTC Corporation. FIG. 5 depicts aircraft in flight shown at the time that the anti-collision lights flash and anti-collision light flashes as the aircraft travels. FIG. 6 depicts some of the other possible flashing sequences on different aircrafts.

In one aspect, provided herein is a detection method 2100. Detection method 2100 includes detecting, at a sensor, a plurality of signals 2102; identifying, at a processor, a relationship between the plurality of signals 2104 and determining, at the processor, whether the relationship between the plurality of signals corresponds to a characteristic of aircraft lights, street lights, or other objects 2106. In accordance with a determination that the relationship corresponds to a characteristic of aircraft lights, (or object), an aircraft-detection (or object-detection) output is generated 2108. In accordance with a determination that the relationship does not correspond to the characteristic of aircraft lights (or object), the aircraft-detection (or object-detection) output is not generated 2110.

In some embodiments, the sensor is a continuous visual sensor.

In some embodiments, the sensor is an event-based visual sensor.

An event-based visual (EVB) sensor can be understood as a category of sensors, which sample the world differently than conventional engineering systems. An event-based sensor may report asynchronously in time that a particular event as occurred. Such an event may be defined as the change of light intensity passing a specified threshold, either indicating a positive change (+ or on), a negative change (− or off) or a change either positive or negative. Since the time to reach threshold may depend on the signal being sampled and the threshold level, the event may occur at any time, in contrast to equal time sampling which may be characterized by their sampling frequency of image frames used in conventional cameras.

A particular EBV sensor is a visual sensor, which may report luminance changes. Such an EBV sensor can be more efficient since large background visual information that typically may not change, is not reported, which may save in processing power and provide efficient signal discrimination.

Regular frame-based conventional cameras may acquire image frames at specific and regular time intervals. Temporal aliasing can result from the limited frame rate of conventional cameras, and as a consequence some signal frequencies can be incorrectly estimated and flashes from anti-collisions lights may be missed. In contrast, event-based vision (EBV) sensors or temporal intensity change sensors may not use frames to acquire visual information but can, rather, report increasing and decreasing luminance changes in with resolution in the nanoseconds (0.000001 ms) or microsecond (0.001 ms) range as events, at times distinguished as positive or negative or either events, respectively. EBV sensors can report the on and off signals of oscillating or flashing lights consistently without missing a beat as long as the lights are in the field of view and the threshold sensitivity is reached. EBV sensors do not report an image; they report events, which may be reconstructed to form a visual image, if desired. In some instances, these events correspond to the edges of objects, because there is often a large change in light intensity there.

Therefore, event-based systems or methods may permit faster and easier detection of these lights on aircrafts and thus permit faster and easier detection of commercial aircrafts. Such systems or methods can be used on aircrafts and drones.

In some embodiments, the sensor may be prefiltered. The sensor may have overactive pixels, which generates a stream of events both without any light and with constant light inputs. In order to reduce the number of events to process, it may be advantageous to pre-filter the events coming from these pixels. The pre-filtering may be as simple as ignoring them at all times, or to treat them differently depending on context, such as global or local light intensity, or intensity changes.

In some embodiments, the following procedure is used. Identification of overactive sensor pixels with no light input, such as with the lens cap on and facing a black wall in a room completely dark room, a set A of overactive pixels is identified. A set B of overactive pixels is identified with the lens cap off, the sensor facing a white wall with uniform light intensity. The light intensity on the wall is changed, and different sets Bare obtained. The intersection of the pixel sets A and B is calculated, and the resulting pixels are considered at all times; they are identified and registered. In general, events coming from such set of pixels may be ignored in the processing software, and if possible the sensor parameters may be set, such as to turn off these pixels such that they do not generate any event. For pixels that are overactive only during a certain range of conditions, for these pixels, the conditions are characterized and again identified and registered. These pixel's events may be ignored in the processing software when the conditions for over-activity are met; for some pixels, this may be in the dark, and others may be during certain light intensity or intensity changes, or other contextual conditions, such as other sensor parameters.

The noise distribution for the sensor pixels is characterized, again during dark and different light intensity conditions. For each pixel, the time distribution, that is the time delay between any two events, positive or negative events, is measured. The time distribution for each pixel for a negative event following a positive event is also determined. For flash detection with the origin at one or more particular pixels, these time distributions may be used to compute the likelihood of a pixel turning on and off from an external input flash relative to internal sensor noise.

Prior to its use, a vision sensor may have some of its response characteristics analyzed and recorded for use in further processing. Some sensors respond to a flash of light (a brief on and off light) by a wave of positive events followed by a similar wave of negative events, which starts at one or more pixels, called the source, and then propagates across neighboring pixels at a characteristic speed of the sensor.

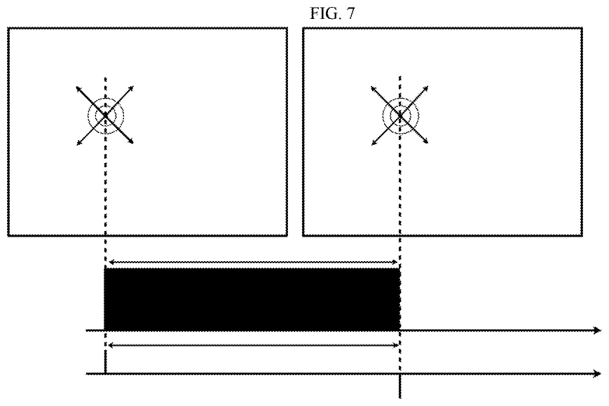

FIG. 7 depicts wave propagation of events on the sensor to adjacent pixels following a flash pulse of light. Event pixel activity is drawn over the physical extend of the sensor. The origin of the wave, the source, is indicated by the origin of the arrows. The source is activated at one or more pixels when the flash is turned on. A positive event is generated at the source, and subsequently a wave of positive events is radially extended towards neighboring pixels. The wave travels a few pixels from the source, which may depend on the intensity of the flash, then stops and disappears. When the flash is turned off, a similar wave appears, but a wave of negative events instead of positive events travels to adjacent pixels. The wave propagation speed can be observed from the data analysis of recording of light flashes.

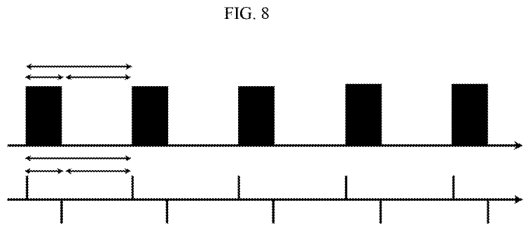

Detection of a flash light may be based on one or more positive events that are followed by the same number of negative events within a specific time interval, which corresponds to the duration of the flash. FIG. 8 depicts flashing sequence and potential event response from a sensor. A regularly repetitive flashing sequence is shown with time running on the x-axes. The black, white above the time axis represents the flashing light turned on, turned off respectively. In the first one from the top, a positive event (above axis) is triggered at the pixel(s) receiving the incoming light of the instantaneous on-flash. Then some time later, at the end of the flash, a negative event (below axis) is triggered at the pixel(s), which suddenly stop receiving the incoming light from the flash (instantaneous off-flash).

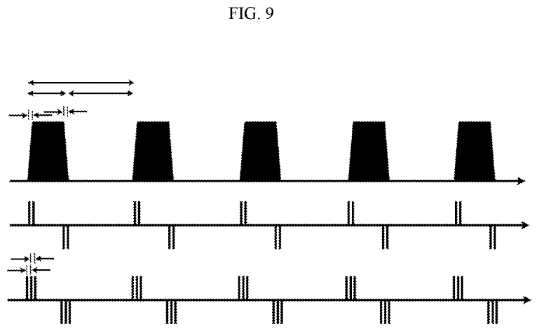

FIG. 9 depicts another flashing sequence and potential event response from sensor. In the first one from the top, a positive event (above axis) is triggered at the pixel(s) receiving the incoming light of the on-flash. The light intensity from the flash takes a finite time to reach its maximum value. During the increase in light intensity, the sensor may respond with one or more positive events (two and three are shown here), depending on the light and sensor parameters (max light intensity, time to reach peak light intensity, sensor threshold, sensor refractory period, etc.). Then some time later, at the end of the flash, the light intensity of the flash takes a finite time to be completely turned off, and one or more negative event (below axis) is triggered at the pixel(s) (two and three shown here), which gradually stop receiving the incoming light from the flash.

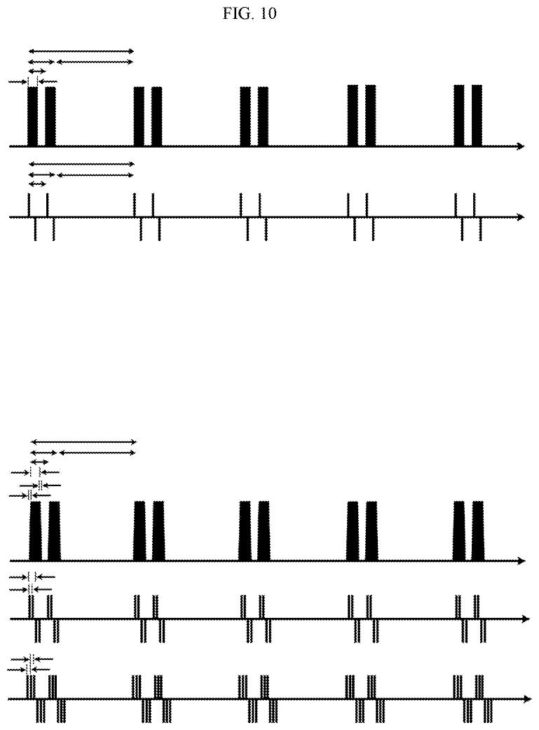

In some cases, the anti-collision lights are two or more close flashes followed by a longer pause period. Examples of the flashing sequences and sensor responses are shown in FIG. 10. The first one assumes an instantaneous on and off change in light intensity from the flash, or a single positive or negative event per pixel, whereas the second set of examples assuming a finite onset and offset for the flash or two or three events per pixel.

In some embodiments, detecting the plurality of signals includes detecting, at the sensor, activation of each of the plurality of signals and detecting, at the sensor, deactivation of each of the plurality of signals. Identifying the relationship between the plurality of signals includes identifying, at the processor, a time difference between activation of each signal and deactivation of the signal.

In some embodiments, the detection method includes determining, at the processor, whether the relationship between the plurality of signals corresponds to a pulse duration of aircraft anti-collision lights.

In some embodiments, measurements estimate that an anti-collision light flash produces activity in the sensor for only a few milliseconds, potentially 6 ms, which is still 6000 times longer than some of the sensor's microsecond time resolution.

In some embodiments, the detection method includes determining, at the processor, whether the relationship between the plurality of signals corresponds to a pulse duration of aircraft steady navigation lights.

In some embodiments, detecting the plurality of signals includes detecting, at the sensor, activation of each of the plurality of signals; detecting, at the sensor, deactivation of each of the plurality of signals. Identifying the relationship between the plurality of signals comprises at least one selected from identifying, at the processor, a time difference between activation of each signal and the activation of the next signal; and identifying, at the processor, a time difference between deactivation of each signal and the deactivation of the next signal.

In some embodiments, the detection method includes determining, at the processor, whether the relationship between the plurality of signals corresponds to a frequency of aircraft anti-collision lights.

The flashing anti-collision lights are readily detectable and, if desired, their frequency determined with an EBV sensor, day or night, with their frequency (40-100 cycles per minutes (0.67 Hz to 1.67 Hz) and with overlap of all lights with a max 180 cycles per minutes (3 Hz-333 ms)) even though the flash duration may be really brief. In some embodiments, measurements estimate that an anti-collision light flash produces activity in the sensor for only a few milliseconds, potentially 6 ms, which is still 6000 times longer than some of the sensor's microsecond time resolution.

In some embodiments, the detection method includes determining, at the processor, whether the relationship between the plurality of signals corresponds to a frequency of aircraft steady navigation lights.

The EBV sensor may report continuous navigation lights on commercial airliners equipped with 400 Hz generators as flickering at 800 Hz (2×400 Hz). Their oscillating frequency may be used to segregate the aircraft navigation lights from background city and other lights.

In some embodiments, identifying the relationship between the plurality of signals includes determining, at the processor, a frequency distribution of the plurality of signals.

In some embodiments, determining the frequency distribution of the plurality of signals includes computing, at the processor, an event-based Fourier Transform or asynchronous discrete time Fourier Transform based on the plurality of signals.

In some embodiments, computing the event-based Fourier Transform based on the plurality of signals includes updating, at the processor, a previously computed event-based Fourier Transform.

It may be advantageous to detect the frequency of a series of flash pulses, such as anti-collision aircraft lights. The following provides different methods for some embodiments.

Given a function y(t) sampled at a set of asynchronous discrete time yᵢ=y(tᵢ), i={0, 1, . . . , }, one version of the asynchronous discrete time Fourier transform of y(t) is given by (Niclas Persson, Event Based Sampling with Application to Spectral Estimation, Thesis No. 981, Linkpöng Studies in Science and Technology, 2001):

$$Y ( f ) = {\sum }_{α}^{k} y ( {t}_{α} ) Δ {t}_{α} {e}^{- i ω {t}_{α}} where ω = 2 π f .$$

To update the asynchronous discrete time Fourier transform as new samples are acquired, we write a recursive equation, which may be computed online:

$${Y}_{k} ( f ) = {Y}_{k - 1} ( f ) + y ( {t}_{k} ) ( {t}_{k} - {t}_{k - 1} ) {e}^{- i ω {t}_{k}}$$

Note that given a series of frequencies {wⱼ}, the Fourier transform at these frequencies is given by:

$${Y}_{k} ( {f}_{j} ) = {Y}_{k - 1} ( {f}_{j} ) + y ( {t}_{k} ) ( {t}_{k} - {t}_{k - 1} ) {e}^{- i {w}_{j} {t}_{k}}$$

In processing a scene from an EBV sensor, this computation may be done for each pixel, pₗ, of the sensor, for example:

$${Y}_{k} ( {f}_{j} , {p}_{l} ) = {Y}_{k - 1} ( {f}_{j} , {p}_{l} ) + y ( {t}_{k} , {p}_{l} ) ( {t}_{k} ( {p}_{l} ) - {t}_{k - 1} ( {p}_{l} ) ) {e}^{- {w}_{j} {t}_{k} ( {p}_{l} )}$$

Note that the value of the sampled signal at tₖ, y(tₖ), is needed. If we are using a sampling of the signal based on send-on-delta reporting scheme, then one could keep an estimate of the analog value of the signal to use for this term based on a reconstruction of the signal from the timing of the events.

A reconstruction of the signal can be obtained by taking an initial measurement of the signal at the beginning. For every positive or negative event, in succession, the signal amplitude may be added or subtracted, respectively from the initial measurement to provide the reconstructed signal at the times of the events. Depending on the type of signals, different interpolation strategy may be used, from linear interpolation to spline fitting of higher polynomials or other functions in other to estimate the values of the signal away from event times.

Instead of reconstructing the signal, some embodiments build an approximation of the signal directly based on the positive and negative events provided by the EBV sensor, which is a transformation invariant to its original frequency, even though the phase may be changed.

For a flash pulse, the level of light intensity may not be the most primary factor of importance, its occurrence is. The brighter it is, the more likely it may be seen by humans.

Before a flash pulse, the initial light intensity may be chosen to be zero. During the flash pulse, the light intensity may be normalized to 1. After the flash pulse, the light intensity is again zero. Essentially, this essentially takes the rise time and decay time to be zero, which is a characteristic of a fast flash pulse.

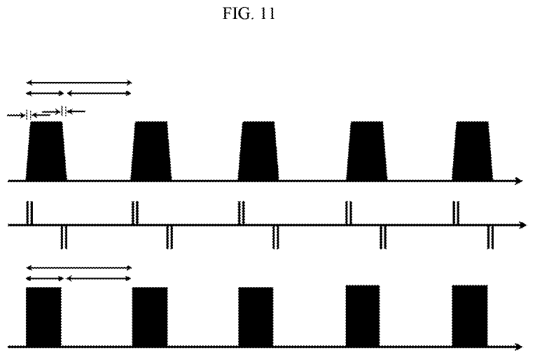

FIG. 11 depicts an original signal encoded by a series of positive and negative events. For the Fourier transform computation, the signal is approximated by an instantaneous rise to a normalized signal value 1 upon a positive event timing and an instantaneous decay to zero as the time of a negative event. As FIG. 11 shows, this approximation does not change the characteristic frequency of the pulses.

Some embodiments use the frequency of the lights as a way to detect them. For example, many streetlights will oscillate at 120 Hz (2*60 Hz).

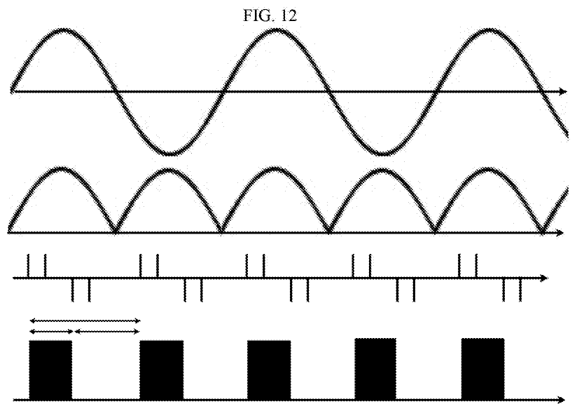

FIG. 12 depicts an example of street light approximation to determine its frequency. The voltage and current to the light filament oscillate at 60 Hz (top sine wave). Whenever the bulb current peaks, it produces a light intensity peak oscillating at 120 Hz (2*60 Hz) (rectified sine wave). As the light intensity increases, decreases, a series of positive, negative events are produced, respectively (above bottom diagram). The light signal may be approximated by a normalized intensity value of 1 at positive events and zero at negative events (bottom diagram). As the figure shows, this approximation does not change the characteristic frequency of the oscillating light.

In the Fourier transform formula,

$$y ( {t}_{k} ) = {e}_{+} ( {t}_{k} ) = \{ \begin{matrix}1 & at {t}_{k} \\ 0 & otherwise\end{matrix} ,$$

where e₊ (tₖ) is a positive event at tₖ:

Yₖ(f)=Yₖ₋₁(f)+e₊(tₖ)(tₖ−tₖ₋₁)e^{iωt}^{ₖ}

We may also use the negative events alone, with

$$y ( {t}_{k} ) = {e}_{-} ( {t}_{k} ) = \{ \begin{matrix}- 1 & at {t}_{k} \\ 0 & otherwise\end{matrix} ,$$

where e₋ is a negative event at tₖ, or together with the positive events,

$$y ( {t}_{k} ) = \{ \begin{matrix}{e}_{+} ( {t}_{k} ) \\ {e}_{-} ( {t}_{k} )\end{matrix} = e ( {t}_{k} ) ,$$

where e(tₖ) is either a positive or a negative event at tₖ.

With the approximation of the signal being normalized to 1 at positive events and normalized to −1 at negative events, the recursive formula for the Fourier transforms is:

Yₖ(f)=Yₖ₋₁(f)+e(tₖ)(tₖ−tₖ₋₁)e^{-iωt}^{ₖ}

In some instances, we may use the negative events only with encoding a +1 instead of a −1,

$$y ( {t}_{k} ) = {e}_{-} ( {t}_{k} ) = \{ \begin{matrix}1 & at {t}_{k} \\ 0 & otherwise\end{matrix} ,$$

which does not change the characteristic frequency, or we may use in combination with the positive events defined above, which doubles the frequency of the signal. The normalization value is not important and can take any value.

The recurrence equation for the Fourier transform accumulates all data in the past. For a varying signal, such as the value the pixel of a sensor in front of a changing visual scene, the Fourier transform may be limited in time to the most recent past.

Some embodiments implement this in two ways, one is to window the signal y(tₖ) over a certain time period in the computation of the Fourier transform, another is to have the values of the Fourier transform decay over a certain time period; in both cases the time period may be set in accordance with the expected changes in visual scene, or may be automatically adapted to the observed changes in the visual scene. This later adaptation may be particularly adapted to EBV sensors, since events themselves report changes in the visual scene. One proposition is to adapt the time period according to the event activity observed for each pixel, such that the time period decreases as the level of pixel event activity increases. The local activity in an area surrounding a pixel is one factor included in the adaptation of the time period.

A rectangular window may be implemented keeping track of the time at which Yₖ(f) was updated, Yₖ(f, tₖ), and then only keep the terms in the sum of Yₖ(f, t=tₖ) from current time t to time tₖ=t−T, where T is the size of the window. By adding a weighting factor [symbol] (t), which varies with time, one may weight events contribution in the past differentially:

Yₖ(f)=Yₖ₋₁(f)+ [symbol] (tₖ)y(tₖ)(tₖ−tₖ₋₁)e^{-iωt}^{ₖ}

For example, [symbol] (t) may be an exponentially decreasing function with time in the past, [symbol] (tₖ)=e^{-γ(t-t}^{ₖ}⁾, such that at the current time the contribution is 1, but as tₖ goes back to early time, [symbol] (tₖ) becomes smaller. It may be implemented using other functions.

To window past data as a function of number of events is done by summing only the contribution from the past [symbol] events, such as:

$${Y}_{k} ( f ) = {\sum }_{a = k - 1}^{k - ℕ} {Y}_{i} ( f ) = {\sum }_{a = k - 1}^{k - ℕ} e ( {t}_{α} ) ( {t}_{α} - {t}_{α - 1} ) {e}^{- i ω {t}_{α}}$$

In addition, for an EBV sensor, [symbol] may be different for different pixels.

Another way to discount past values is to use a discounting factor acting on the values of Yₖ(f), such as, for example:

Yₖ(fⱼ)=(1−α)Yₖ₋₁(fⱼ)+y(tₖ)(tₖ−tₖ₋₁)e^{-iw}^{ⱼ}^{t}^{ₖ}

where α is a number between 0 and 1; and there are other ways to provide a discount in a recursive formula.

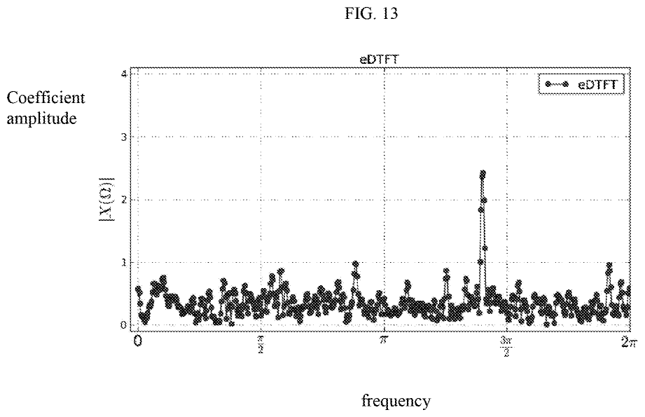

FIG. 13 depicts the asynchronous discrete time Fourier transform of a sine wave sampled stochastically.

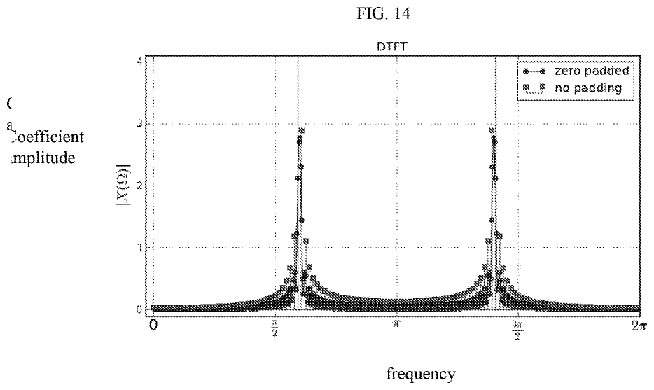

FIG. 14 depicts a traditional discrete time Fourier transform of the same sine function.

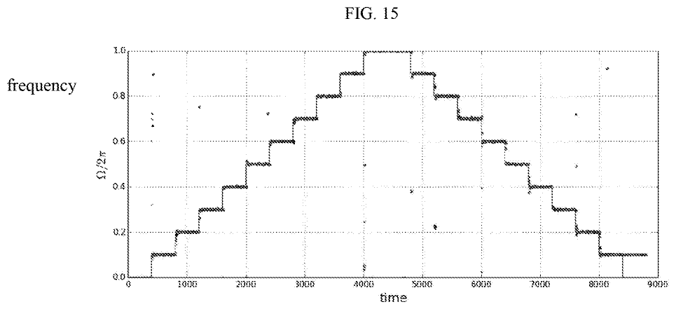

FIG. 15 depicts the asynchronous discrete time Fourier transform of a sine wave sampled stochastically for which the frequency was systematically changed every 400 time steps. A discounting factor α, like above was used to discount some of the earlier Yₖ (fⱼ).

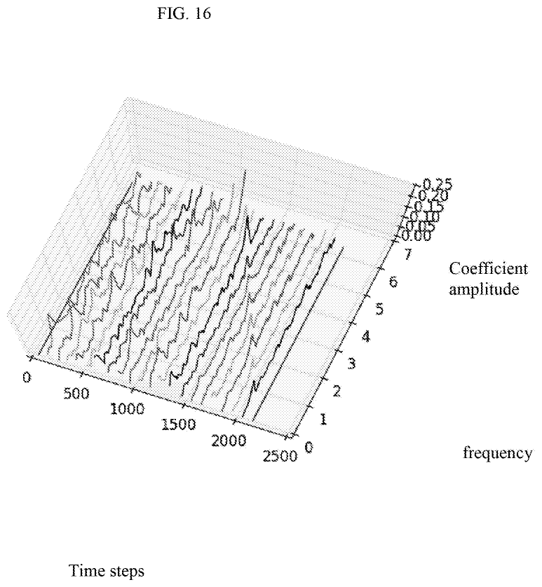

FIG. 16 depicts the asynchronous discrete time Fourier transform of a sine wave sampled stochastically for which the frequency was systematically changed every 100 time steps. Time is 0 to 2500 axis, frequency is the 0 to 7 (−2π) axis, and the z axis is the amplitude of the Fourier transform Yₖ(fⱼ). The frequency with the peak Fourier amplitude goes from 1 at time 100 to 21 at time 1000 then decreases back to 1 at 2000.

In order to determine the frequency of a moving stimulus, some embodiments relate the activity at a pixel to the previous activity at another pixel. The eFT is then computed by the correspondence:

Yₖ(fⱼ,pₗ)=Yₖ₋₁(fⱼ,pₗ)+y(tₖ,pₗ)(tₖ(pₗ)−tₖ₋₁(pₘ))e^{-iw}^{ⱼ}^{t}^{ₖ}^{(p}^{ₗ}⁾

where the pixel pₗ and pₘ are related by the relative motion of the stimulus on the sensor.

Once the relative motion between the stimulus and the sensor is estimated or observed using possible different methods, this determines the pixels, which are to be used for the eFT above. One example is in the case of flash pulses from anti-collision lights as the aircraft pursue its trajectory.

Below is a non-limiting list of possible mechanisms to estimate the motion of the flash source and of the drone, which all of them may be combined for more precision.

Stabilizing sensor
Physical stabilization—Gimbal—rotation compensation

Sensor Motion Estimation—Electronic Stabilization
Visual
Inertial
   Inertial Motion Unit
   GPS
Auditory
Magnetic
Atmospheric Pressure
Other sensory modality
Combined Motion Estimation

Aircraft Motion Estimation—Aircraft Tracking
Flash localization and extrapolation
Optic Flow Velocity
Optic Flow Acceleration
Aircraft Tracking (edge following)

In some embodiments, the detection method includes determining, at the processor, whether the relationship between the plurality of signals corresponds to a frequency of aircraft anti-collision lights.

The flashing anti-collision lights are readily detectable and, if desired, their frequency determined with an EBV sensor, day or night, with their frequency (40-100 cycles per minutes (0.67 Hz to 1.67 Hz) and with overlap of all lights with a max 180 cycles per minutes (3 Hz-333 ms)) even though the flash duration may be really brief. In some embodiments, measurements estimate that an anti-collision light flash produces activity in the sensor for only a few milliseconds, potentially 6 ms, which is still 6000 times longer than some of the sensor's microsecond time resolution.

In some embodiments, the detection method includes determining, at the processor, whether the relationship between the plurality of signals corresponds to a frequency of aircraft steady navigation lights.

The EBV sensor may report continuous navigation lights on commercial airliners equipped with 400 Hz generators as flickering at 800 Hz (2×400 Hz). Their oscillating frequency may be used to segregate the aircraft navigation lights from background city and other lights.

In some embodiments, the detection method includes removing all sources of lights known not to be from aircrafts before detecting activation of signals.

Even though many lights look like another light with a conventional camera, with an EBV sensor because of their time resolution, an aircraft steady navigation lights can be distinguished further from a city background lights, since many of the city lights do flicker at 120 Hz (2×60 Hz). Most lights being connected to the electrical grid with alternating current (AC) oscillate at that frequency. The oscillations are reported as rapid succession of on and off events at 120 Hz by the EBV sensor. Fluorescent lights and other lights may oscillate at different frequencies depending on the electrical sources powering theses lights. Certain lights have their own transformers, which modify the alternating current frequencies, mainly at higher frequencies. Some EBV sensor response is still sufficiently fast to detect the fluorescent and other higher oscillations at key locations on such lights, and may be distinguished using their oscillating frequency, different than 120 Hz (2×60 Hz).

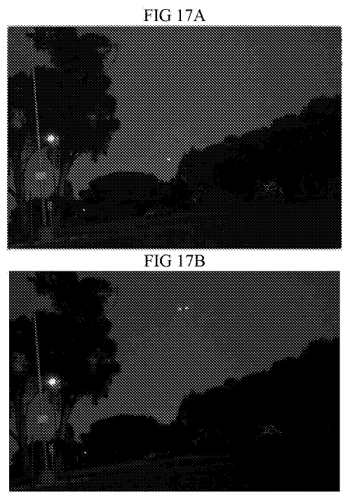

FIGS. 17A and 17B depict photos of a plane landing captured by a conventional video camera. There are 3 main light sources: the plane, a street light on the left, middle height, and another street light on the left, bottom. Black & white image (FIG. 17A) of a plane landing (near center of the image, between the trees), two street lights can be seen: one is on the lamppost to the right, at middle height in the image, and another lamppost is in the distance near the ground, piercing through the trees between the first lamppost and the plane lights.

In the situation of FIG. 17, the EBV sensor reports three light points, two are eliminated as lampposts, and the third is the only aircraft candidate left. This third point is further identified in parallel as an aircraft by the other methods, and particularly, the first method, which detects the flashing anti-collision lights in the right frequency range.

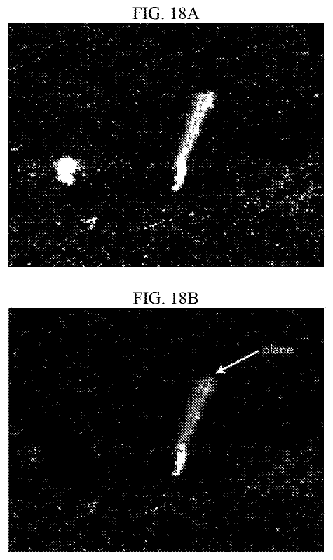

Signal processing with the EBV sensor identifies the pixels oscillating at 120 Hz, and thus, in this image, the two visible lampposts (FIG. 17B). These two sets of pixels are thus eliminated as potential aircraft lights in FIG. 18B. The scale of the two set of images (FIG. 17 and FIG. 18) is not identical because the conventional camera and the EBV sensor used did not have the same field of view.

Accumulated events from the EBV sensor over the same time span as the images in the video of the plane landing: (FIG. 18A) all 3 main sources of lights present, two street lights and the plane; (FIG. 18B) after filtering for oscillating street lights, the main light source remaining is the plane together with some transient sensor pixel activity (noise), which may be filtered out.

FIGS. 18A and 18B depict images from accumulated events from an EBV sensor of a plane landing: (FIG. 18A) all events including plane, street lights and noise are accumulated into a single image as the plane travels between the locations shown in FIGS. 17A and 17B; (FIG. 18B) all events associated with the street lights are removed from FIG. 18 according to their oscillating frequencies and the result shown.

In some embodiments, the detection method includes identifying the shape of the aircraft.

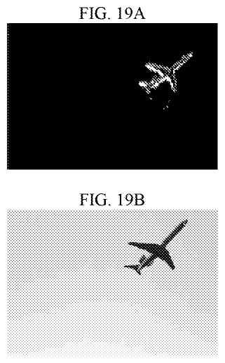

The EBV sensor reports very distinctly the outline of an aircraft in the sky, which is already one step towards the abstraction or generalization of the typical shape of an aircraft. This sparse sensory data can make for efficient and fast identification of an aircraft by its shape, which adds robustness to the three previous methods above. An example is shown in FIGS. 19A and 19B, with the EBV sensor aircraft contour on the left shown compared to the plane image using a conventional camera on the right. With the EBV, only the changing pixels, here due to the aircraft, are activated. FIG. 19 depicts the comparison between the aircraft contour captured with an EBV sensor (FIG. 19A) and the aircraft image captured with a conventional camera (FIG. 19B).

In some embodiments, the detection method includes filtering the lights before detecting activation of signals.

The light changes can be further filtered in many different ways before reaching threshold and used to generate an event. For example, the light may be filtered by red, blue, or green filters or light could be segregated in other ways (e.g. prisms) to generate events in relation with respectively red, blue, or green light intensity changes. In some embodiments, each event is associated with the filter characteristics, e.g. one could talk of red, blue or green events, even though the events themselves are colorless. Similarly, the filter could be selecting lights of particular polarization, linear, circular or others, and an event could be associated with the change of light intensity with that particular polarization. Event generations may occur in some proportion from one filter and another, and can be quantified. When events are generated (nearly) simultaneously in particular proportions, the original color of the light may be inferred if needed. A flashing white light, for example, could generate as nearly many events in the sensors filtered by red, blue, and green filters.

In this way, red, green and white events from color EBV sensors could be used to distinguish the color of anti-collision lights or navigation lights (continuously on) to determine the relative direction of travel of the aircraft.

In the evening and at night, one way, which can help identify an aircraft, is to filter all background lights, which are not from an aircraft. These include different city and street lights, ground vehicles, and different obstruction lights on buildings, ground vehicles, high-rise buildings, chimneys, poles, towers, water towers, storage tanks, bridges, wind turbines, catenary and catenary support structures. Most lights, which are connected to the alternating current electric grid oscillates at 120 Hz and can readily be filtered out.

Obstruction lights are regulated by the Department of Transportation, FAA and other government entities. These lights are typically well marked on maps and other available databases, including navigation maps for airways and waterways. Their specific locations provide a first hint to their origin, and are integrated into our onboard systems.

Furthermore, the different obstruction lights are either steady lights (red or white) or are flashing at specific frequencies (e.g. in the US, 60 flashes per minute, or 1 Hz, for lights installed on catenary or catenary support structures and 40 flashes per minute, or 0.67 Hz, for any obstruction light installed on any other structure).

Both set of lights may either be filtered out by their 120 Hz oscillations, and/or by their location and flashing frequency, and/or by their flashing patterns when there are more than one, and/or by their relative locations and flashing sequences (steady and flashing, which are well characterized—e.g. see US Department of Transportation FAA AC 70/7460-1K publication, AC 150/5345-43G publication).

For example, for catenary structures (AC 150/5345-43G publication):
This system consists of three lighting levels on or near each supporting structure. One light level is near the top, one at the bottom or lowest point of the catenary, and one midway between the top and bottom.
The flash sequence must be middle, top, and bottom.
The interval between the beginning of the top and the beginning of the bottom flashes must be about twice the interval between the beginning of the middle and the beginning of the top flashes.
The interval between the end of one sequence and the beginning of the next must be about 10 times the interval between middle and top flashes.
The time for the completion of one cycle must be one second (±5 percent).

The flash characteristics for obstruction lights are provided, for example, in the US from AC 150/5345-43G publication, which is shown in Table 1.

TABLE 1

| Type | Intensity Step | Flash rate ⁽¹⁾ | Flash Duration ⁽²⁾ |
|---|---|---|---|
| L-856 | Day & Twilight | 40 FPM | Less than 100 ms |
| L-856 | Night | 40 FPM | Between 100 and 250 milliseconds (ms) inclusive |
| L-857 | Day & Twilight | 60 FPM | Less than 100 ms |
| L-857 | Night | 60 FPM | Between 100 and 250 ms inclusive |
| L-864 | Single | 20-40 FPM | ½ to ⅔ of flash period if incandescent |
| | | | lighting ⁽³⁾, and between 100 and 2000 ms |
| | | | inclusive if other lighting sources. |
| L-865 | Day & Twilight | 40 FPM | Less than 100 ms |
| L-865 | Night | 40 FPM | Between 100 and 1000 ms inclusive |
| L-866 | Day & Twilight | 60 FPM | Less than 100 ms |
| L-866 | Night | 60-FPM | Between 100 and 250 ms inclusive |
| L-885 | Single | 60 FPM | ½ to ⅔ of flash period if incandescent lighting ⁽³⁾, |
| | | | and between 100 and 670 ms inclusive if other |
| | | | lighting sources. |

NOTES:
⁽¹⁾ Flash rates have a tolerance of ±5 percent.
⁽²⁾ When the effective flash duration is achieved by a group of short flashes, the short flashes must be emitted at a rate of not less than 50 Hz.
⁽³⁾ The light intensity during the “off” period must be less than 10 percent of the peak effective intensity. The “off” period must be at least ⅓ of the flash period.

In some embodiments, all the factors above are used to filter out lights not belonging to an aircraft.

Some city lights, such as fluorescent lighting with electronic ballasts may increase oscillating frequency of 60 Hz AC beyond 20 kHz, which may not give enough time for the light intensity to fluctuate significantly; it may therefore appear as a steady on light to some of the EBV sensors.

Lights running on direct current (DC), such as used with some LEDs, or in vehicles can be considered always on lights, and a priori do not oscillate, and do also appear always on to an EBV sensor. Nevertheless, some lights may still appear to oscillate, in a vehicle for example, due to mechanical perturbations of the filament, which may modify the light intensity.

Since steady lights or fluctuating lights in vehicles are very rarely accompanied with flashing anti-collision lights of aircrafts, some embodiments may readily eliminate those lights as emanating from an aircraft.

Similarly, airport lights can be filtered out using their specific characteristics (FAA AC 150/5345-51B): Flash rate of 60 flashes per minute (1 Hz) for some lights, and 120 flashes per minute (2 Hz) for another types of lights.

Similarly, the emergency lights on vehicles may be distinguished using their frequency, their color and other parameters.

In some embodiments, the detection method includes determining light intensity.

Integrate situational cues, such as whether the moving lights are in the sky, or near or on the ground. Unless near an airport, moving lights on the ground are likely to be from ground vehicles and not aircrafts. On a flying platform, like a drone or aircraft, the horizon may be determined via the onboard IMU (inertial motion unit), which may indicate the relative position of the flying platform relative to the gravity vector.

In some embodiments, an EBV sensor detects an aircraft through one or more of: 1) Detect the flashes of the anti-collision lights, 2) Detect the steady navigation lights on the aircraft, which for many commercial airliners may actually be oscillating at 800 Hz, 3) Identify lights in a video, or continuous stream of visual inputs, then identify aircraft lights by removing all sources of lights known not to be from an aircraft, such as city and street lights, etc., 4) Identify visually the shape of the aircraft and 5) Adding filters to the light before falling on the photosensors, e.g. to detect colors, 6) Combine event-based sensor data as well as light intensity data, 7) Integrate situational cues, such as whether the moving lights moving are in the sky, or near or on the ground. In some embodiments, all methods listed above for detecting an aircraft in different combinations.

In some embodiments, a filtering process associated with a continuous visual sensor may permit faster, easier detection of commercial aircrafts for sense and avoid system to be used on aircrafts, drones and other uses.

In some embodiments, a method for direct activity-based flash determination is as follows.

With an EBV sensor, an anti-collision pulse is characterized by a short succession of positive event(s) from one or many pixels, followed by a short succession of negative event(s) at the same pixel(s).

The method here describes the detection of a flash of light, which is typically of higher intensity than the previous light intensity at a location in space. The same method may be applied to detecting a negative flash, or sudden reduction in light intensity compared to the previous light; one simply replaces in the description positive by negative events and vice versa.

Detection of single flash pulse. For every positive event, the event time and pixel are recorded. For every negative event, check if there has been a previous positive event at that pixel, if yes, compute the time difference between the positive event and negative event. If the time difference between the time of the negative event and the positive event is between a min and a max value, DTmin and DTmax, respectively, then time and pixel for the positive and negative events are stored for future processing as potential flash pulse P_i, then increase i.

For every new Pi, compute the asynchronous Fourier transform, eFT. If eFT(P_i, for all, or a subset of pulse flash P_i) has a frequency distribution, which peaks between fmin and fmax (0.67 Hz to 1.67 Hz in the USA), then store and label the set of Pi as flash pulses.

Pseudo-code algorithm description is provided below.

Initialize:

n = 0

For ever loop:

• Given a positive polarity event (+event) at a pixel i given
by (x_i, y_i):

∘ Record T+(x,y) = t, where t is the timestamp
of the event

• Given a negative polarity event (−event) at pixel i:

▪ Record T_−(x, y) = t,

∘ Compute DT(x_i, y_i) = T_−(x, y) − T_+(x, y)

▪ If DFmin < DT(x_i, y_i) < DFmax:

• Record flash F(n, x_i, y_i, T_+(x, y),
T_−(x, y ), DT(x_i, y_i)

For ever loop: (describe in pseudo-code, what's in the text above)

In some embodiments, a machine learning system is trained to identify the flash. Using labeled data, or via unsupervised methods. Labeled data can be understood as data which has been examined and labeled by a human operator as being a flash pulse. Unsupervised methods can be understood as methods that find in autonomous fashions differences in the data, such as independent component analysis.

In some embodiments, a machine learning system is trained to identify an aircraft using EBV sensor and traditional camera. The machine learning system may be a deep network using deep learning.

In some embodiments, likelihood of a flash is determined based on time distribution.

In some embodiments, active vision discrimination is conducted. Positive event(s) followed by negative event(s) at one or more pixels within a particular range of intervals may indicate the occurrence of a flash of light. If the flash activates only one pixel, there is the possibility that these maybe cause by random sensor noise.

In order to enhance the disambiguation between flash and pixel noise, one solution is to constantly move by potentially different means the sensor very rapidly along small trajectories or if not the sensor, the input light coming in to the sensor, such as by moving the lens, or another optical device in front of the sensor, such that an external light flash activates more than one pixel along a pixel trajectory corresponding to how the sensor or light was moved arriving at the sensor. In contrast, random sensor noise will very likely not activate more than one pixel within the time frame of a flash.

Such systems can be made possible with EBV sensors. The rapid motion of a traditional vision camera may result in blurred images, not a series of pixel event activation.

In some embodiments, transform-based flash identification can be frequency-based or wave-based. In some embodiments, frequency-based discrimination is conducted as described below:

Different possibilities:
Compute eFT (event-based Fourier Transform) using all events
   Anti-collision lights are detected as lights with events with a constant high frequency (flash—on/off events) together with a constant low frequency between 40-100 cycles per minutes (0.67 Hz to 1.67 Hz), together with the frequency all across the whole aircraft with a constant low frequency maximum of 180 cycles per minutes (3 Hz)
Compute eFT using only flash events
   Then determine only the frequencies of flashes, constant low frequency between 40-100 cycles per minutes (0.67 Hz to 1.67 Hz), together with the frequency all across the whole aircraft with a constant low frequency maximum of 180 cycles per minutes (3 Hz)

Instead of entering polarity of event e, p(e), to compute eFT, pre-filter for flashes, then compute eFT for these flash events only, ignoring the other events.

In some embodiments, wave-based discrimination is conducted as described below. The sensor response during flashes is characterized by a propagation of activity along the sensor, which is larger the larger the light intensity appears to be. The propagation can be modeled as a 2D wave expansion from a single source.

One issue may be to resolve the flashes from pixel sensor noise, particularly when the flash is far in the distant and may cover one pixel or less.

Referring to FIG. 7, a flash pulse (middle) has an onset when the light turns on and offset when the light turns off. A possible encoding with positive event (left) and negative event (right) is shown at the bottom. The positive event occurs at the onset at one or many pixels on the sensor (top, left) at the source. From the source, a propagating wave starts to move outward to adjacent pixels with a particular velocity, to disappear after some pixel distance. The same phenomenon repeats for the negative event (top, right).

One way to identify the flash pulse with the sensor is to characterize the wave propagation to neighboring pixels.

To use transforms, the propagating wave of positive/negative events is characterized by kx−wt where the ratio k/w is related to the propagation speed. The wave propagation determines a relationship between the spatial frequency and the temporal frequency, which can be verified by combining the spatial Fourier transform and the temporal Fourier transform. For each sensor, the speed of propagation may be obtained and recorded. A flash pulse may be detected when the wave is present for both positive and negative events (on and off part of the pulse) and furthermore when the speed of propagation of the measured wave corresponds to the one previously measure for the sensor.

Using pixel sampling around the source. In some embodiments, a flash pulse is detected via the following method. Given the speed of wave propagation measured for the sensor, given one event at a pixel source, a series of surrounding pixels are observed to determine whether their event time is consistent with the propagating wave or not. If they are, a pulse is detected, otherwise not. The surrounding pixels may be a subset of all surrounding pixels for improving the speed of processing. For example, one may limit sampling to pixels in 5, 7, 9, 11, 13 or different number of directions around the source and sample only one, two, three or more distance in pixels away from the source.

Non-stationary flash source on sensor surface. In this case, the flash source and sensor are moving relative to one another. It could be that the flash source (aircraft) is moving while the sensor remains fixed, or that the aircraft is fixed (e.g. on the ground) and the sensor is on a moving flying drone, or that both the flash source and sensor are moving.

Below is a list of possible mechanisms to estimate the motion of the flash source and of the drone, which all of them may be combined for more precision.

Stabilizing sensor
Physical stabilization—Gimbal—rotation compensation

Sensor Motion Estimation—Electronic Stabilization
Visual
Inertial
   Inertial Motion Unit
   GPS
Auditory
Magnetic
Atmospheric Pressure
Other sensory modality
Combined Motion Estimation

Aircraft Motion Estimation—Aircraft Tracking
Flash localization and extrapolation
Optic Flow Velocity
Optic Flow Acceleration
Aircraft Tracking (edge following)

Event-based processing. Changes in the world, such as the flash from anti-collision aircraft lights, produces a sudden increase then decrease in light intensity, which propagates at the speed of light. These light signals generate positive and negative events when they arrive at an EVS, or a temporal intensity change sensor. In some embodiments, the temporal sequence of these events is analyzed to determine the duration of the flash and its frequency within different time intervals (e.g., short and long intervals). The location of synchronized or nearly synchronous events is tracked on the sensor sensitive surface.

In parallel, a state estimation can be computed in order to effectively track the synchronous events on the sensor sensitive surface. Both frequency and state estimation may be transposed into a representation providing the location in 2D or 3D in the external world taking into account other variables, such as the sensor orientations relative to the vehicle.

State estimation (such as location, velocity, acceleration) of events may be combined with their frequency estimation to optimize tracking of the events and by consequence, tracking of the aircraft as a whole. In some embodiments, the aircraft is modeled as undergoing a solid object transformation in continuous time and space with limited speed and acceleration appropriate for commercial and other aircrafts.

In some embodiments, flashing light is tracked by combining anti-collision light detection and optic flow.

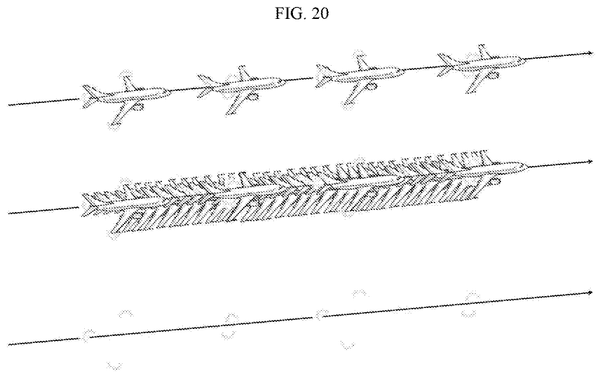

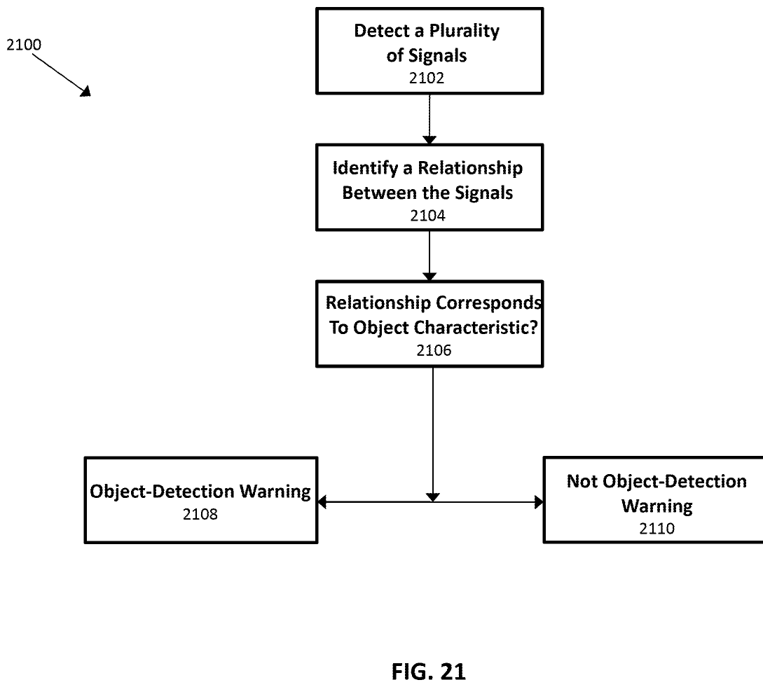

FIG. 20 illustrates a scheme for estimating the motion of an aircraft for tracking the anti-collision lights over time. The middle section represents the continuous motion of the aircraft, which is the input for optic flow computation. The optic flow can be used to estimate the velocity and acceleration of the aircraft as seen by the sensor to estimate the aircraft position in the future. Given the aircraft position in the future, the localization of the flash in pixel positions may be estimated in order to provide, for example the correspondence required in the asynchronous Fourier transform to estimate the anti-collision lights frequency.

In another aspect, provided is a detection system. The detection system includes a sensor that detects a plurality of signals; a processor that identifies a relationship between the plurality of signals and determines whether the relationship between the plurality of signals corresponds to a characteristic of aircraft lights; and a output module that generates an aircraft-detection output in accordance with a determination that the relationship corresponds to a characteristic of aircraft lights.

In some embodiments, the sensor detects activation of each of the plurality of signals and deactivation of each of the plurality of signals and the processor identifies a time difference between activation of each signal and deactivation of the signal.

In some embodiments, the characteristic is a pulse duration of aircraft anti-collision lights.

In some embodiments, the characteristic is a pulse duration of aircraft steady navigation lights.

In some embodiments, the sensor detects activation of each of the plurality of signals and deactivation of each of the plurality of signals and the processor identifies a relationship between the plurality of signals comprising at least one selected from: a time difference between activation of each signal and the activation of the next signal; and a time difference between deactivation of each signal and the deactivation of the next signal.

In some embodiments, the characteristic is a frequency of aircraft anti-collision lights.

In some embodiments, the characteristic is a frequency of aircraft steady navigation lights.

In some embodiments, the processor identifies a relationship between the plurality of signals comprising a frequency distribution of the plurality of signals.

In some embodiments, the processor computes an event-based Fourier Transform based on the plurality of signals.

In some embodiments, the processor updates a previously computed event-based Fourier Transform.

In some embodiments, the characteristic is a frequency of aircraft anti-collision lights.

In some embodiments, the characteristic is a frequency of aircraft steady navigation lights.

In some embodiments, the sensor is a continuous visual sensor.

In some embodiments, the sensor is an event-based visual sensor.

In some embodiments, the system includes a module for removing all sources of lights known not to be from aircrafts before detecting activation of signals.

In some embodiments, the system includes a module for filtering the lights before detecting activation of signals.

In some embodiments, the system includes a module for identifying the shape of the aircraft.

In some embodiments, the system includes a module for determining light intensity.

In some embodiments, the system includes a module for determining situational cues.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

1. An aircraft detection method comprising:
detecting, at a sensor, a plurality of signals;
identifying, at a processor, a relationship between the plurality of signals;
determining, at the processor, whether the relationship between the plurality of signals corresponds to a characteristic of aircraft lights;
in accordance with a determination that the relationship corresponds to a characteristic of aircraft lights;
generate an aircraft-detection output; and
in accordance with a determination that the relationship does not correspond to the characteristic of aircraft lights;
forego generating the aircraft-detection output.

2. The method of claim 1, wherein detecting the plurality of signals comprises:
detecting, at the sensor, activation of each of the plurality of signals; and
detecting, at the sensor, deactivation of each of the plurality of signals; and
wherein identifying the relationship between the plurality of signals comprises:
identifying, at the processor, a time difference between activation of each signal and deactivation of the signal.

3. The method of claim 2, wherein the characteristic is a pulse duration of aircraft anticollision lights.

4. The method of claim 2, wherein the characteristic is a pulse duration of aircraft steady navigation lights.

5. The method of claim 1, wherein detecting the plurality of signals comprises:
detecting, at the sensor, activation of each of the plurality of signals; and
detecting, at the sensor, deactivation of each of the plurality of signals; and
wherein identifying the relationship between the plurality of signals comprises at least one selected from:
identifying, at the processor, a time difference between activation of each signal and the activation of the next signal; and
identifying, at the processor, a time difference between deactivation of each signal and the deactivation of the next signal.

6. The method of claim 5, wherein the characteristic is a frequency of aircraft anti-collision lights.

7. The method of claim 5, wherein the characteristic is a frequency of aircraft steady navigation lights.

8. The method of claim 1, wherein identifying the relationship between the plurality of signals comprises:
determining, at the processor, a frequency distribution of the plurality of signals.

9. The method of claim 8, wherein determining the frequency distribution of the plurality of signals comprises:
computing, at the processor, an event-based Fourier Transform based on the plurality of signals.

10. The method of claim 9, wherein computing the event-based Fomier Transform based on the plurality of signals comprises:
updating, at the processor, a previously computed event-based Fourier Transform.

11. The method of claim 8, wherein the characteristic is a frequency of aircraft anti-collision lights.

12. The method of claim 8, wherein the characteristic is a frequency of aircraft steady navigation lights.

13. The method of claim 1, wherein the sensor is a continuous visual sensor.

14. The method of claim 1, wherein the sensor is an event-based visual sensor.

15. The method of claim 1, further comprising removing all sources of lights known not to be from aircrafts before detecting activation of signals.

16. The method of claim 1, further comprising filtering the lights before detecting activation of signals.

17. The method of claim 1, further comprising identifying the shape of the aircraft.

18. The method of claim 1, further comprising determining light intensity.

19. The method of claim 1, further comprising determining situational cues.

20. An aircraft detection system, comprising:
a sensor that detects a plurality of signals;
a processor that identifies a relationship between the plurality of signals and determines whether the relationship between the plurality of signals corresponds to a characteristic of aircraft lights;
an output module that generates an aircraft-detection output in accordance with a determination that the relationship corresponds to a characteristic of aircraft lights.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)
